(19) United States
(12) Patent Application Publication
(10) Pub. No.: US 2026/0125551 A1
(43) Pub. Date: May 7, 2026

(54) BINDING COMPOSITION FOR ORE AGGLOMERATES

(71) Applicant: SNF Group, ANDREZIEUX-BOUTHEON (FR)

(72) Inventors: Cédrick FAVERO, ANDREZIEUX-BOUTHEON (FR); Gilles ZAKOSEK, ANDREZIEUX-BOUTHEON (FR); Aurélien BONNEAU, ANDREZIEUX-BOUTHEON (FR); Aurélien DUCHADEAU, ANDREZIEUX-BOUTHEON (FR)

(73) Assignee: SNF Group, ANDREZIEUX-BOUTHEON (FR)

(21) Appl. No.: 19/122,983

(22) PCT Filed: Oct. 25, 2023
(86) PCT No.: PCT/EP2023/079729

§ 371 Date: Apr. 21, 2025

(30) Foreign Application Priority Data
Nov. 4, 2022 (FR) FR2211510

(51) Int. Cl. C08L 33/26; C22B 1/244

(52) U.S. Cl. CPC C08L 33/26; C22B 1/244; C08L 2205/025

(57) ABSTRACT

The present invention relates to a binding composition, for the manufacture of ore agglomerates, comprising at least the following two distinct organic binding agents CP1 and P2:
a polymeric composition CP1 comprising a non-ionic or anionic water-soluble synthetic polymer P1 with a weight average molecular weight of between 500,000 and 3 million Daltons,
a non-ionic or anionic water-soluble synthetic polymer P2 with a weight average molecular weight greater than 2 million Daltons,
   wherein the polymeric composition CP1 and the polymer P2 are both present in the form of solid particles,
   wherein P1 is obtained by a gel polymerization process of at least one non-ionic or anionic monomer in the presence of:
at least 1% by weight of a polymer P3, said polymer P3 contains at least one hydrophobic monomer, or
at least one hydrophobic monomer,
   the polymeric composition CP1 comprising from 0.1% to 20% by weight of the at least one hydrophobic monomer, said hydrophobic monomer being polymerized.

The invention also relates to an ore agglomerate containing between 2,000 and 50,000 ppm of this binding composition.

### FIELD OF THE INVENTION

The invention belongs to the technical field of ore agglomerates. The invention relates to a binding composition improving, in particular, the agglomeration step for obtaining ore low-temperature agglomerates. Said binding composition comprises a mixture of at least two organic polymeric binding agents. The invention also relates, as a product, to an ore agglomerate containing said binding composition.

### PRIOR ART

Most metals are obtained from ores found in their natural state in the ground or in mines. During the first stage of the recovery process for said metals, the element of interest, i.e., the metal (for example iron to make steel), is recovered from the melted ore in a blast furnace. In order to be introduced directly into this blast furnace, the ore of the element of interest must be in a standard form of significant size. If this is not the case, it is necessary to convert the ore particles into agglomerates larger than the particle size. Agglomeration is a process based on the adhesion of ore particles to each other. Five agglomeration technologies exist in metallurgy: briquetting, nodulization, extrusion, pelletization and sintering. These techniques are known and described in numerous documents such as the work “Agglomeration in Industry” by Wolfgang Pietsch or, in particular, in patent EP 0097486. Nowadays, the increasing use of lower quality ores forces manufacturers to grind the ore finer, which makes the agglomeration step essential.

During this agglomeration step, the use of a bonding agent or a binding composition is necessary to ensure good physical properties such as the mechanical strength of the agglomerates. A “binding agent” or a “binding composition” makes it possible to optimize the adhesion of the ore particles between them in order to form an agglomerate having sufficient mechanical properties allowing it to resist the vibrations and movements to which it is subjected during its various handling operations.

Among the binding agents traditionally used, mention will be made of cement (Portland), clays and more particularly bentonites, starch, cellulose, molasses, optionally by combining them with lime, etc. The use of these binding agents poses problems given the high presence of impurities which are harmful to the industrial process (such as the sulfur impurity for the steel industry) and/or leads to agglomerates having unsatisfactory physical properties. In recent years, new binding compositions have been developed by manufacturers to counter these undesirable effects. Documents U.S. Pat. No. 5,002,607 and EP 2,548,978 describe processes for which agglomerates are produced using a binding composition comprising at least one synthetic polymer of organic nature and at least one inorganic binding agent.

U.S. Pat. No. 5,833,937 relates to a method comprising a binding step involving the sequential addition to mineral fines of a solution of anionic polymers and a solution of cationic polymers.

Generally, agglomerates such as iron ore pellets are formed by adding a binding agent to crushed ores and agitating it in the presence of a small amount of water to form a wet mixture, then shoveling the mixture to form (wet) green pellets. These green pellets are then fired in an oven from an entry temperature of 200-400° C. to a final temperature of almost 1400° C. Such a process for forming iron ore pellets is disclosed in document EP 0 225 171, for example.

For the final agglomerate to have good physical properties, the baking step is essential. However, this step is very energy-intensive in terms of fossil matter. This has a considerable impact on agglomerate plants, both ecologically and economically.

In view of the current energy situation, it is more than necessary to find sustainable and effective solutions that make it possible to obtain quality agglomerates, i.e., respecting the physical properties expected from the technique, while combining productivity and energy savings.

One of the solutions found by manufacturers to limit the impact of manufacturing these agglomerates was to agglomerate the ore at low temperature, i.e., at a firing temperature not exceeding 250° C. Unfortunately, this type of process does not make it possible to obtain the expected physical properties of the agglomerates, on the basis of the binding compositions mentioned above. The agglomerates crack before they even reach production equipment such as blast furnaces. Their handling becomes arduous and their storage is difficult.

The present invention overcomes the drawbacks of the prior art by disclosing a binding composition improving the agglomeration step in order to allow manufacturing ore agglomerates at low temperature with satisfactory physical properties.

### DISCLOSURE OF THE INVENTION

The invention relates to a binding composition for the manufacture of ore agglomerates generally at low temperature, comprising at least the following two distinct organic binding agents (a polymeric composition CP1 and a polymer P2 having the function of distinct organic binding agents):
a polymeric composition CP1 comprising a non-ionic or anionic water-soluble synthetic polymer P1 with a weight average molecular weight of between 500,000 and 3 million Daltons,
a non-ionic or anionic water-soluble synthetic polymer P2 with a weight average molecular weight greater than 2 million Daltons,
   the polymeric composition CP1 and the polymer P2 are both present in the form of solid particles, wherein P1 is obtained by a gel polymerization process of at least one non-ionic or anionic monomer in the presence of:
at least 1% by weight of a polymer P3, said polymer P3 contains at least one hydrophobic monomer, by weight of P1 or
at least one hydrophobic monomer,
   the polymeric composition CP1 comprising from 0.1% to 20% by weight of the at least one hydrophobic monomer, said hydrophobic monomer being polymerized.

Another aspect of the invention relates to an ore agglomerate comprising between 2,000 and 50,000 ppm of said binding composition, relative to the weight of the ore agglomerate.

### DISCLOSURE OF THE INVENTION

### Definitions and Generalities

In the present application, the term “polymer” denotes both homopolymers and copolymers of at least two distinct monomers.

As used herein, the term “water-soluble polymer” means a polymer giving an aqueous solution without insoluble particles when dissolved with stirring for 4 hours at 25° C. and with a concentration of 20 g·L⁻¹ in 1 deionized water.

An “anionic polymer” means a polymer containing at least one anionic monomer and optionally at least one non-ionic monomer. A “non-ionic polymer” means a polymer containing only one or more non-ionic monomers. In general, a polymer containing a monomer means a polymer obtained by polymerization of a multitude of molecules of this monomer.

As used herein, the term “hydrophilic monomer” means a monomer whose octanol/water partition coefficient Kow is less than 1, determined at a temperature of 25° C. and with a pH of between 6 and 8.

The term “hydrophobic monomer” designates a monomer whose octanol/water partition coefficient Kow is greater than 1, determined at a temperature of 25° C. and with a pH of between 6 and 8.

The octanol/water partition coefficient Kow is defined as follows:

$$Kow = \frac{[ monomer ] octanol}{[ monomer ] water}$$

where [monomer]octanol=equilibrium monomer concentration in g/L in n-octanol, and [monomer]water=equilibrium monomer concentration in g/L in water.

According to the invention, the term “low temperature” means a temperature not exceeding 250° C.

In the present application, the term “agglomerate” relates to the product resulting from a agglomeration technology chosen from among pelletization, sintering, nodulization, briquetting or extrusion.

The “solid particles” according to the present invention are always defined by their sizes. The median size (D₅₀) in number of solid particles is defined as the largest dimension (which is the diameter in the case of spherical particles) of the particles, half of the particle population being below this value. Particle size refers to the average diameter measured using a laser diffraction particle analyzer according to conventional techniques known to a person skilled in the art. An example of a device for measuring mean diameter is the Mastersizer from Malvern Instruments.

According to the invention, the ranges of values include the lower and upper limits. Thus, the ranges of values “between 0.1 and 1.0” and “from “0.1 to 1.0” include the values 0.1 and 1.0.

According to the present invention, the weight average molecular weight of the polymers is determined by measuring the intrinsic viscosity. The intrinsic viscosity can be measured by any method known to a person skilled in the art. It is calculated, in particular, by the method of measuring viscosity in solution, which consists in determining reduced viscosity values for different concentrations according to a graphical method consisting in plotting the reduced viscosity values (on the ordinate axis) as a function of the concentration (on the abscissa axis), then extrapolating the curve to zero concentration. The intrinsic viscosity value is read on the ordinate axis or using the least squares method. Next, the weight average molecular weight is determined by the Mark-Houwink equation:

$$[ η ] = K \cdot {M}^{α}$$

where [η] represents the intrinsic viscosity of the polymer determined by the solution viscosity measurement method,
K represents an empirical constant,
M represents the molecular weight of the polymer, and
α represents the Mark-Houwink coefficient.
α and K depend on the particular polymer-solvent system. Tables known to a person skilled in the art give the of a and K values according to the polymer-solvent system.

### Polymeric Composition CP1 and Polymer P1

The binding composition according to the invention comprises a polymeric composition CP1 comprising a non-ionic or anionic water-soluble polymer P1 with a weight average molecular weight of between 500,000 and 3 million (=3.106) daltons, more preferably between 500,000 and 2,500,000 daltons, and even more preferably between 500,000 and 2,000,000 daltons.

Advantageously, the anionic monomer(s) of the water-soluble polymer P1 is preferably chosen from the group comprising monomers having a vinyl function, in particular acrylic, maleic, fumaric, malonic, itaconic, or allylic. It may also contain at least one carboxylate, phosphonate, phosphate, sulfonate, or another anionically charged group. Preferred monomers belonging to this class are, for example, acrylic acid, methacrylic acid, itaconic acid, crotonic acid, maleic acid, fumaric acid, acrylamidoundecanoic acid, 3-acrylamido 3-methylbutanoic acid, maleic anhydride, 2-acrylamido-2-methylpropane sulfonic acid (ATBS), vinylsulfonic acid, vinylphosphonic acid, 2-sulfoethylmethacrylate, sulfopropylmethacrylate, sulfopropylacrylate, 1 allylphosphonic acid, styrene sulphonic acid, 2-acrylamido-2-methylpropane disulphonic acid, their salts and their mixtures. Preferably, it is acrylic acid or itaconic acid. Even more preferably, it is acrylic acid.

Thus, in a particular embodiment of the invention, the anionic monomer(s) may be salified.

By “salified”, it is meant that at least one acid function of the anionic monomer is replaced by a salt neutralizing the negative charge of the acid function. In other words, the non-salified form corresponds to the acid form of the monomer, for example R—C(═O)—OH in the case of the carboxylic acid function, whereas the neutralized form of the monomer corresponds to the R—C(═O)—O⁻ X⁺ form, X⁺ corresponding to a salt with a positive charge. The neutralization of the acid functions of the water-soluble polymer may be partial or total. The salified form advantageously corresponds to the salts of alkali metals (Li, Na, K, etc.), alkaline-earth metals (Ca, Mg, etc.) or ammonium (for example, the ammonium ion or a tertiary ammonium). Preferred salts are the sodium salts. The salification may take place before or after the polymerization.

As explained above, this does not exclude the presence, in the polymer P1, of at least one anionic monomer unit containing carboxylic acid functions (not neutralized). In other words, the simultaneous presence of anionic monomers with carboxylic acid functions and the same monomers with carboxylate functions is possible.

Even more preferably, the polymer P1 comprises at least one anionic monomer containing a carboxylate function which is a salt of acrylic acid. Advantageously, the polymer P1 contains at least sodium acrylate as a monomer unit.

In a preferred embodiment of the invention, the water-soluble polymer P1 does not contain a monomer unit having a sulphonic acid function or its salts, such as acrylamido tert-butyl sulphonic acid (ATBS), allyl sulphonic acid or methallyl sulfonic acid.

Advantageously, the water-soluble polymer P1 contains less than 50 mol % of anionic monomer(s), preferably between 10 and 40 mol %, more preferably between 15 and 30 mol %.

Advantageously, the non-ionic monomer(s) may be chosen, in particular, from the group comprising water-soluble vinyl monomers. The non-ionic monomer(s) are chosen, for example, from the group containing acrylamide, methacrylamide, N-vinylformamide (NVF), N-vinyl acetamide, N-vinylpyridine, N-vinylpyrrolidone (NVP), N-vinyl imidazole, N-vinyl succinimide, acryloyl morpholine (ACMO), acryloyl chloride, glycidyl methacrylate, glyceryl methacrylate, diacetone acrylamide, hydroxyalkyl (meth)acrylates (the group alkyl being advantageously C₁-C₃), aminoalkyl (meth)acrylates (the alkyl group being advantageously C₁-C₃), aminoalkyl (meth)acrylamido (the alkyl group being advantageously C₁-C₃), thioalkyl (meth)acrylate (the alkyl group being advantageously C₁-C₃) and mixtures thereof. Preferably, at least one non-ionic monomer of the polymer P1 is acrylamide.

The polymer P1 advantageously comprises at least 50 mol %, preferably between 60 to 90 mol %, and even more preferably between 70 to 85 mol % of at least one non-ionic monomer.

The total sum of the monomers is equal to 100% of the polymer P1.

According to a preferred embodiment, the polymer P1 is non-ionic.

Preferably, the polymer P1 is a copolymer of acrylamide and sodium acrylate, which preferably comprises between 10 and 40 mol % and even more preferably between 15 and 30 mol % of sodium acrylate, the total sum of the two monomers preferably being equal to 100% of the polymer P1.

In one embodiment of the present invention the polymer P1 contains hydrophobic monomers.

The hydrophobic monomer(s) of the polymer P1 have a Kow partition coefficient greater than 1 and are preferably chosen from the compounds of the following list:
(meth)acrylic acid esters having an alkyl and/or arylalkyl and/or ethoxylated and/or propoxylated chain; (meth)acrylamide derivatives having an alkyl and/or arylalkyl and/or dialkyl and/or ethoxylated and/or propoxylated chain; anionic hydrophobic derivatives of (meth)acryloyl; and anionic monomer derivatives of (meth)acrylamide bearing a hydrophobic chain;
n-hexyl (meth)acrylate, n-octyl (meth)acrylate, octyl (meth)acrylamide, n-tert-butyl (meth)acrylamide, lauryl (meth)acrylate, (lauryl meth)acrylamide, myristyl (meth)acrylate, myristyl (meth)acrylamide, pentadecyl (meth)acrylate, pentadecyl (meth)acrylamide, cetyl (meth)acrylate, cetyl (meth)acrylamide, oleyl (meth)acrylate, oleyl (meth)acrylamide, crucyl (meth)acrylamide, crucyl (meth)acrylamide, and combinations thereof;
hydrophobic monomers corresponding to the general formula

CH₂═CR¹—COO-(EO)ₙ—(PO)ₘ—R²
wherein R¹ is hydrogen or methyl; n is a number at least equal to two, preferably between 6 and 100, even more preferably between 10 and 40; m is a number between 0 and 50, preferably between 0 and 20, EO is an ethylene oxide group (—CH₂—CH₂—O—), PO is a propylene oxide group (—CH₂—CH(CH₃)—O—) and R² is a C₈-C₃₀ alkyl group or a C₈-C₃₀ arylalkyl group, and n+m preferably being from 6 to 100 or from 10 to 40. They are preferably linear alkyls.

Among the hydrophobic monomers of P1 having an alkyl chain, in particular the esters of (meth)acrylic acid, the derivatives of (meth)acrylamide, the alkyl groups are advantageously C₁-C₅, more advantageously C₁-C₃. They are preferably linear alkyls. Therefore, a dialkyl group comprises two alkyl groups, advantageously C₁-C₅. The arylalkyl groups of these monomers are advantageously C₈-C₃₀.

More preferably, the hydrophobic monomers of P1 are chosen from the compounds of the following list: halogenalkyl (preferably bromoalkylated) derivatives of methacrylamidodimethyl aminopropyl comprising a C₈-C₁₆ alkyl chain, ethoxylated behenyl methacrylate, diethylacrylamide, n-tert-butylacrylamide and mixtures thereof.

Advantageously, according to a preferred embodiment, the polymer P1 comprises at least one hydrophobic monomer chosen from haloalkyl derivatives of methacrylamidodimethyl aminopropyl comprising a C₈-C₁₆ alkyl chain, ethoxylated behenyl methacrylate, diethylacrylamide, n-tert-butylacrylamide, and their mixtures.

The polymer P1 may be linear or structured. By “structured polymer” is meant a non-linear polymer which has side chains to obtain, when this polymer is dissolved in water, a strong state of entanglement leading to very high low-gradient viscosities. The structuring may come from the presence of at least one polyethylenically unsaturated monomer (i.e., having at least two unsaturated carbon=carbon functions), such as, for example, the vinyl, allylic, acrylic and epoxy functions. Mention may be made, for example, of sodium allyl sulfonate, sodium methallyl sulfonate, sodium methallyl disulfonate, methylenebisacrylamide, diallylamine, triallylamine, triallylammonium chloride, or tetraallylammonium chloride. The structuring may also be obtained by at least one macroinitiator such as polyperoxide or polyazo, or by at least one transfer polyagent such as polymercaptan.

The polymer P1 may also be structured using controlled radical polymerization (CRP) techniques, more particularly of the reversible addition fragmentation chain transfer (RAFT) type.

The polymer P1 may be structured in the form of a comb, a star or any other structure known to a person skilled in the art. The structured polymer P1 remains water-soluble.

Advantageously, the polymer P1 is structured in the form of a star, i.e., it has a central part (called the core) and arms based on polymers extending radially from said central part.

According to the invention, the polymeric composition CP1 is in the form of solid particles, with a median size in number of solid particles (D₅₀) generally greater than 500 micrometers (μm).

Preferably, the polymer P1 is obtained by a gel polymerization process of at least one non-ionic or anionic monomer in the presence of:
at least 1% by weight of a polymer P3 of at least one hydrophobic monomer, or
at least one hydrophobic monomer,

the polymeric composition CP1 comprising from 0.1% to 20% by weight of the at least one hydrophobic monomer, said hydrophobic monomer being polymerized.

In one embodiment of the invention, the polymer P1 is obtained by a gel polymerization process of at least one non-ionic or anionic monomer in the presence of at least 1% by weight of a polymer P3 of at least one hydrophobic monomer,

the polymeric composition CP1 comprising from 0.1% to 20% by weight of the at least one hydrophobic monomer, said hydrophobic monomer being polymerized within polymer P3. In this embodiment, the polymeric composition CP1 consists of polymer P1 and polymer P3.

In another embodiment of the invention, the polymer P1 is obtained by a gel polymerization process of at least one non-ionic or anionic monomer in the presence of at least one hydrophobic monomer,

the polymeric composition CP1 comprising from 0.1% to 20% by weight of the at least one hydrophobic monomer, said hydrophobic monomer being polymerized within polymer P1. In this embodiment, the polymer P1 comprises the at least hydrophobic monomer. In this embodiment, the polymeric composition CP1 consists of polymer P1.

According to the invention, “A and/or B” means either A, or B, or A and B.

The gel polymerization of the process of the invention is carried out free-radically. This includes free radical polymerization using UV, azo, redox or thermal initiators, as well as controlled radical polymerization (CRP) techniques, more particularly of the RAFT type.

At least one transfer agent may be used. It may, in particular, be chosen from sulfur compounds such as thioglycolic acid, or a mercapto alcohol, or dodecyl mercaptan; amines such as ethanolamine, diethanolamine or morpholine; and phosphites such as sodium hypophosphite. In the case of a RAFT-type polymerization, one or more specific polymerization regulators such as those comprising a transfer group comprising the —S—CS-function, may be used. Mention may, in particular, be made of compounds of the family of xanthates (—S—CS—O—), dithioesters (—S—CS-Carbon), trithiocarbonates (—S—CS—S—), or dithiocarbamates (—S—CS-Nitrogen). Among the compounds of the xanthate family, O-ethyl-S-(1-methoxycarbonylethyl) xanthate may be advantageously used because of its compatibility with monomers of acrylic nature.

The polymerization initiator(s) used to obtain the polymer P1 may be any compound which dissociates into radicals under the polymerization conditions, such as, for example: organic peroxides, hydroperoxides, hydrogen peroxide, persulfates, azo compounds and redox catalysts. The use of water-soluble initiators is preferred. In some cases, it is advantageous to use mixtures of various polymerization initiators, for example, mixtures of redox catalysts and azo compounds.

Said polymerization initiators are used in the usual quantity, for example, in a quantity which may vary from 0.0001 to 2%, preferably from 0.001 to 1% by weight, with respect to the monomers to be polymerized.

As oxidant components, the redox catalysts advantageously contain at least one of the aforementioned compounds. As a reducing component, the redox catalysts are advantageously chosen from ascorbic acid, glucose, sorbose, hydrogen sulphite, sulphite, thiosulphate, hyposulphite, pyrosulphite, an alkali metal, metallic salts, such as in the form of iron (II) ions or silver ions or sodium hydroxymethylsulfoxylate. The reducing component of the redox catalyst preferably used is Mohr's salt (NH₄)₂Fe(SO₄)₂, 6 H₂O.

By way of example, based on the quantity of monomers used in the polymerization, 5×10⁻⁶ at 1 mol % of the reducing component of the redox catalyst system and 5×10⁻⁵ at 2 mol % of the oxidizing component of the redox catalyst may be used. Instead of the oxidant component of the redox catalyst, one or more water-soluble azo initiators may also be used.

The polymerization of the water-soluble polymer P1 is carried out in the absence of oxygen by introducing the initiators in the appropriate order, known to a person skilled in the art, into the solution to be polymerized. The initiators are introduced either in soluble form in an aqueous medium, or in the form of a solution in an organic solvent.

All the constituents are advantageously dissolved, more advantageously in water.

As soon as the polymerization begins, the reaction mixture is heated or warms up (exothermic reaction) depending on the starting conditions chosen. Advantageously, due to the released heat of polymerization, the temperature of the reaction mixture rises from 80 to 150° C., preferably from 80° C. to 100° C. The polymerization is advantageously carried out at atmospheric pressure. A person skilled in the art knows how to choose the appropriate equipment for optimal polymerization.

At the end of the polymerization reaction, the polymer gel P1 is left to age, generally for at least 60 minutes.

“Aging” means leaving the gel in the polymerization reactor at the final polymerization temperature.

The product resulting from the polymerization is generally a viscous polymer gel P1 which is then granulated. Granulation consists of cutting the gel into small pieces. According to the present invention, advantageously, the average size of these pieces of gel is less than 1 cm, more advantageously between 4 and 8 mm. A person skilled in the art knows how to choose the appropriate means for optimum granulation. The next step is to grind these pieces of gel. The grinding step consists of breaking large particles of polymer into smaller particles. This may be done by shearing or by mechanical crushing of the particle between two hard surfaces. Different types of equipment, known to a person skilled in the art, may be used for this purpose, such as, for example, rotor mills, where the particle is crushed on a compression blade using the rotating part, or roller mills, where the particle is crushed between two rotating rollers. The sieving that follows the grinding is then intended to eliminate, depending on the specifications, medium-sized particles, or too small or too large particles. The next step is to dry the polymer P1. The drying means and its conditions (time+temperature) are routine choices for a person skilled in the art. Industrially, the drying is advantageously carried out by a fluidized bed or rotor dryer, advantageously using air heated to a temperature of between 70° C. and 200° C., the temperature of the air being a function of the nature of the product as well as the drying time applied. The product obtained is the polymeric composition CP1. The polymeric composition CP1 is then in powder form.

### Polymer P3

According to one aspect of the invention, the polymer P1 is preferably characterized in that it is obtained by a gel polymerization process known to a person skilled in the art, in the presence of at least 1% by weight of a polymer P3, of at least one hydrophobic monomer. In addition to the hydrophobic monomer(s), the polymer P3 may comprise at least one hydrophilic monomer. In this case, the polymeric composition CP1 consists of the polymer P1 and the polymer P3.

The hydrophilic monomer(s) of the polymer P3 have a Kow partition coefficient of less than 1 and are preferably chosen from the group containing acrylamide, methacrylamide, N-alkylacrylamides, N-alkylmethacrylamides, N,N-dialkyl acrylamides, N,N-dialkylmethacrylamides, alkoxylated esters of acrylic acid, alkoxylated esters of methacrylic acid, N-vinylpyridine, N-vinylpyrrolidone, hydroxyalkylacrylates, hydroxyalkyl methacrylates, and mixtures thereof; monomers having a carboxylic acid function and their salts, including acrylic acid, methacrylic acid, itaconic acid, and maleic acid; monomers having a sulphonic acid function and their salts, including acrylamido tertio butyl sulphonic acid (ATBS), allyl sulphonic acid and methallyl sulphonic acid, and their salts; monomers having a phosphonic acid function and their salts; and their mixtures. In general, the monomer salts are salts of at least one alkali metal (preferably sodium), of at least one alkaline-earth metal (preferably calcium or magnesium) or of at least one ammonium (preferably a quaternary ammonium).

The hydrophobic monomer(s) of the polymer P3 have a Kow partition coefficient greater than 1 and are preferably chosen from the compounds of the following list:
(meth)acrylic acid esters having an alkyl and/or arylalkyl and/or ethoxylated and/or propoxylated chain; (meth)acrylamide derivatives having an alkyl and/or arylalkyl and/or dialkyl and/or ethoxylated and/or propoxylated chain; anionic hydrophobic derivatives of (meth)acryloyl; and anionic monomer derivatives of (meth)acrylamide bearing a hydrophobic chain;
n-hexyl (meth)acrylate, n-octyl (meth)acrylate, octyl (meth)acrylamide, n-tert-butyl (meth)acrylamide, lauryl (meth)acrylate, (lauryl meth)acrylamide, myristyl (meth)acrylate, myristyl (meth)acrylamide, pentadecyl (meth)acrylate, pentadecyl (meth)acrylamide, cetyl (meth)acrylate, cetyl (meth)acrylamide, oleyl (meth)acrylate, oleyl (meth)acrylamide, erucyl (meth)acrylamide, erucyl (meth)acrylamide, and combinations thereof;
hydrophobic monomers corresponding to the general formula

CH₂═CR¹—COO-(EO)ₙ—(PO)ₘ—R²

wherein R¹ is hydrogen or methyl; n is a number at least equal to two, preferably between 6 and 100, even more preferably between 10 and 40; m is a number between 0 and 50, preferably between 0 and 20, EO is an ethylene oxide group (—CH₂—CH₂—O—), PO is a propylene oxide group (—CH₂—CH(CH₃)—O—) and R² is a C₈-C₃₀ alkyl group or a C₈-C₃₀ arylalkyl group, and n+m preferably being from 6 to 100 or from 10 to 40. They are preferably linear alkyls.

Among the hydrophobic monomers of P3 having an alkyl chain, in particular the esters of (meth)acrylic acid, the derivatives of (meth)acrylamide, the alkyl groups are advantageously C₁-C₅, more advantageously C₁-C₃. They are preferably linear alkyls. Therefore, a dialkyl group comprises two alkyl groups, advantageously C₁-C₅. The arylalkyl groups of these monomers are advantageously C₈-C₃₀.

More preferably, the hydrophobic monomers of P3 are chosen from the compounds of the following list: halogenalkyl (preferably bromoalkylated) derivatives of methacrylamidodimethyl aminopropyl comprising a C₈-C₁₆ alkyl chain, ethoxylated behenyl methacrylate, diethylacrylamide, n-tert-butylacrylamide and mixtures thereof.

The polymer P3 contains between 10 and 100% by weight, and even more preferably between 10 and 90% by weight, of at least one hydrophobic monomer.

Advantageously, the polymer P3 is a terpolymer of diethylacrylamide, n-tert-butylacrylamide and sodium 2-acrylamido-2-methylpropanesulfonate.

In a preferred embodiment, the polymer P3 is functionalized at the end of the polymer chain by at least one group chosen from: hydroxyl, cyano, amine, phosphate, phosphonate, sulphate, sulphonate, xanthate, trithiocarbonate, dithiocarbamate, and dithioester. Said polymer P3 may also be free of functionalization of its chain.

Preferably, the polymer P3 is free of any carbon-carbon double bond.

According to this aspect of the invention, the polymer P1 is obtained according to the following conditions:
Preparation of an aqueous solution of polymer P1 comprising between 1 and 25% by weight, advantageously between 2 and 20% by weight, and even more advantageously between 3 and 15% by weight, of polymer P3, the % being expressed by weight relative to the total weight of the aqueous solution, the polymer P3 containing the monomers chosen from the list described above; some water; and, optionally, additives, the total mass concentration of monomers being between 10 and 60%, advantageously between 20 and 55% and even more advantageously between 25 and 50%, by weight relative to the total weight of the aqueous solution. The polymerization compounds are dissolved, for example with stirring, in the aqueous medium to be polymerized. This solution, also called charge to be polymerized, is adjusted to an initiation temperature between −20° C. and 50° C. Advantageously, this initiation temperature is adjusted between −5° C. and 30° C., and even more advantageously between 0 and 20° C. The person skilled in the art knows how to define the pH to be reached as well as the quantity and the choice of pH regulators according to the chemistry of the polymer to be synthesized, according to the nature of the monomers (non-ionic, anionic, etc.).
Degassing after dissolution in order to eliminate any trace of residual oxygen, thanks to at least one inert gas. The inert gas is usually passed through the solution. Inert gases suitable for this purpose are, for example, nitrogen, carbon dioxide or rare gases such as neon or helium. Argon may also be used.

The hydrophilic monomers present in the polymer P3 can promote the solubilization of the polymer P3 in water, even when it mainly comprises hydrophobic monomers. In this case, the hydrophilic monomers play the role of co-solvent of the polymer P3. Thus, the polymerization solution is devoid of insoluble elements. In general, the polymer P1 is water-soluble while the polymer P3 is not necessarily.

According to a second aspect of the invention, the polymer P1 is obtained by a gel polymerization process in the presence of at least one hydrophobic monomer. In this specific case, the polymer P1, in addition to its anionic and/or nonionic water-soluble monomer(s) described above, comprises at least one hydrophobic monomer.

The hydrophobic monomers are generally chosen from the same list of hydrophobic monomers as that cited above for the polymer P3. To do this, preferably, from 1 to 20% of at least one hydrophobic monomer are introduced into the polymerization charge of P1. However, preferably, the polymer P3 and P1 do not contain any cationic monomer or any zwitterionic monomer.

According to this aspect of the invention, optionally, this or these hydrophobic monomers are brought into contact with one or more surfactants.

A “surfactant” is an agent capable of emulsifying an oil in water. Generally, a surfactant is considered to be a compound with an HLB greater than or equal to 10.

The hydrophilic-lipophilic balance (HLB) of a chemical compound is a measure of how hydrophilic or lipophilic it is, determined by calculating the values of different regions of the molecule, as described by Griffin in 1949. Griffin assigned a dimensionless number between 0 and 20, to give information on water and oil solubility. Substances with an HLB value of 10 are distributed between the two phases such that the hydrophilic group (molecular mass Mh) projects completely into water while the hydrophobic group (molecular mass Mp) is adsorbed in the non-aqueous phase. The HLB value of a substance having a total molecular mass M and a hydrophilic part of a molecular mass Mh is given by:

$$HLB = 20 ( Mh / Mp )$$

The surfactant may be any suitable surfactant chosen from anionic surfactants, cationic surfactants, non-ionic surfactants and a combination thereof. In some embodiments, the surfactant(s) may exist as dimers. For example, the surfactant may comprise one polar headed group and two nonpolar tailed groups, or two polar headed groups and one nonpolar tailed group, or two polar headed groups and two nonpolar tailed groups. The surfactant, or mixture of surfactants, may be chosen from the compounds of the following list: ethoxylated sorbitan esters such as ethoxylated sorbitan oleate with 20 moles of ethylene oxide (EO210), sorbitan laurate with 20 moles of ethylene oxide or ethoxylated sorbitan monostearate with 20 moles of ethylene oxide; decaethoxylated oleodecyl alcohol; heptaethoxylated lauryl alcohol; castor oil ethoxylated with 40 moles of ethylene oxide; polyethoxylated alkyl phenols; polyethoxylated cetyl ethers; derivatives of quaternary amines; sodium lauryl sulphate; fatty alcohol condensation products with ethylene oxide; condensation products of alkyl phenols with ethylene oxide; amino fatty acid condensation products with 5 or more ethylene oxide units; tristerylphenol ethylene oxide; an alkyl polyglucoside; an amine oxide, a glucamide; a salt of alkylbenzene sulfonic acid, a water-soluble surfactant polymer. Preferably, less than 10% by weight of surfactants are added to the polymerization charge.

### Polymer P2

The binding composition according to the invention comprises, in addition to the polymeric composition CP1 comprising polymer P1, a non-ionic or anionic water-soluble synthetic polymer P2 with a weight average molecular weight greater than 2 million (2.106) Daltons. The water-soluble polymer P2 has a weight average molecular weight more preferably greater than 5 million Daltons. The water-soluble polymer P2 has a weight average molecular weight generally less than 40 million Daltons. The polymer P2 comprises at least one non-ionic or anionic monomer.

Preferably, the polymer P2 has a weight average molecular weight greater than the weight average molecular weight of the polymer P1.

The non-ionic and anionic monomers are preferably chosen from the same compounds mentioned above for P1. Advantageously, the anionic monomer(s) may be salified as previously described.

Preferably, the water-soluble polymer P2 contains between 5% and 100 mol %, more preferably between 10% and 70 mol %, and even more preferably between 20% and 50% mol %, of at least one anionic monomer.

Advantageously, the water-soluble polymer P2 does not contain a monomer unit having a sulphonic acid function or their salts, such as acrylamido tert-butyl sulphonic acid (ATBS), allyl sulphonic acid and methallyl sulphonic acid.

The polymer P2 is linear or structured. The polymer P2 may be structured as described above for P1. The structured P2 polymer remains water-soluble.

The polymer P2 is present in the form of solid particles, for example in the form of powder or microbeads. The powder of the polymer P2 may be obtained by gel polymerization, by precipitation polymerization, or by polymerization in aqueous solution followed by drum drying or spray drying or radiation drying such as micro-drying by waves or drying in a fluidized bed. The powder form may also be obtained by water-in-oil emulsion polymerization (inverse emulsion), followed by a distillation/concentration step and spray-drying of the resulting liquid.

The P2 polymer microbeads are advantageously obtained by reverse suspension polymerization.

Preferably, the polymer P2 is in the form of a powder resulting from gel polymerization or microbeads resulting from reverse suspension polymerization.

According to the invention, the polymer P2 is in the form of solid particles, such that the median size in number of the solid particles (D₅₀) is greater than 500 micrometers (μm).

Particularly preferably, the polymer P2 is a copolymer containing between 5 and 100 mol % of sodium acrylate.

### Binding Composition According to the Invention

With the objective of the agglomeration of ores at low temperature, the binding composition according to the invention comprises at least two polymers having the function of distinct organic binding agents: the polymeric composition CP1 and P2.

According to a preferred embodiment of the invention, the binding composition contains at least 50% by weight of polymeric composition CP1.

According to a preferred embodiment of the invention, the binding composition contains only the two distinct organic binding agents the polymeric composition CP1 and P2. According to this preferred embodiment, the binding composition preferably contains between 75 and 90% by weight of polymeric composition CP1 and between 10 and 25% by weight of polymer P2. The sum of the quantities by weight of CP1+P2 is equal to 100%.

According to another embodiment of the invention, the binding composition may also contain at least one other constituent of a different nature, making it possible to increase the physical properties of the agglomerates and to even further improve the binding power of said composition.

One of these constituents may be an organic bonding agent other than CP1 and P2, for example an epoxy, polyphenolic or formaldehyde resin. Rolkem™ brand resins are preferred.

Thus, according to another aspect of the invention, the binding composition comprises less than 40% by weight of polymeric composition CP1, between 1 and 25% by weight of polymer P2 and at least 50% by weight of another organic binding agent other than CP1 and P2, the sum of the amounts by weight of the components being equal to 100%.

The binding composition may also comprise an inorganic binding agent, advantageously in the form of solid particles, denoted LI below. The inorganic binding agent LI may be chosen from sodium carbonate, sodium bicarbonate, sodium phosphate, sodium silicate, urea, calcium oxide, bentonite and mixtures thereof. A preferred LI inorganic bonding agent is sodium silicate. According to the invention, the binding agent LI may be present in the form of solid particles, such that the median size of the solid particles (D₅₀) is between 500 and 5000 micrometers, more preferably between 500 and 2000 micrometers.

Thus, according to an alternative embodiment of the invention, the binding composition comprises at least 50% by weight of the inorganic binding agent LI, between 10% and 49% by weight of the polymeric composition CP1 and between 0.5 and 5% by weight of the polymer P2, the sum of the amounts by weight of CP1+P2+LI being equal to 100%.

Another embodiment of the invention relates to a binding composition containing between 10 and 40% by weight of the inorganic bonding agent LI, between 5 and 20% by weight of the polymeric composition CP1, at least 50% by weight of another organic bonding agent than P1 and P2 and less than 5% by weight of the polymer P2, the sum of the amounts by weight of the components being equal to 100%.

The binding composition according to the invention is formed by mixing its constituents, each of them being in powder form.

The binding composition particularly preferably contains less than 0.1% by weight of sulfur element.

### Agglomerates

The last aspect of the invention relates to an ore agglomerate advantageously containing between 2,000 and 50,000 ppm of binding composition relative to the weight of said ore agglomerate.

Agglomerates are generally formed by adding the binding composition to ground ores under stirring in the presence of a small amount of water to form a wet mixture. The mixture is then agglomerated using the preferred agglomeration technique (pelletizing, sintering, nodulization, extrusion or briquetting). The agglomerates thus obtained are then fired in an oven at a temperature not exceeding 250° C.

Said agglomerates may undergo additional subsequent physical and/or chemical treatments depending on the desired application, as is known to a person skilled in the art.

### EXAMPLES

The following examples help to best illustrate the advantages of the invention in a clear and non-limiting manner.

### I. Synthesis of a Polymer P1 and Polymeric Composition CP1:

### Example 1 (P1a: Counterexample): Synthesis by Aqueous Liquid Route of a Low Molecular Weight Acrylamide Homopolymer P1a

The polymer P1a is synthesized by an aqueous liquid radical polymerization process from an aqueous charge comprising 40.0% by weight of acrylamide monomers according to the following protocol: in a 1 L jacketed reactor are introduced in order: 133 g of water and 6 g of sodium hypophosphite. The pH of the aqueous phase is adjusted to a pH value between 2.0 and 3.0 using a dilute solution of sulfuric acid. The charge is then heated to a temperature between 79 and 81° C. using the jacketed reactor. When the aqueous charge is at temperature, 800 g of a 50% by weight solution of acrylamide in water is poured over a period of 120 minutes. In parallel, a solution of sodium persulfate at 6.5% by weight in water is poured over a period of 130 minutes. When the casting of sodium persulfate is complete, the whole is left to react for 1 hour at the same temperature to reduce the level of residual monomers. The polymer P1a is obtained in the form of a viscous liquid comprising 40% by weight of polymer. The polymer P1a has a molecular mass of 100,000 Daltons.

### Example 2 (CP1b and P1b: Invention): Synthesis by Gel Route of a Polymeric Composition CP1b Comprising an Acrylamide/Sodium Acrylate Copolymer P1b, by Adding to the Polymerization Charge 2% by Weight of Polymer P3 Containing 83% by Weight of Hydrophobic Monomer

During a first step, polymer P3 of composition by weight: 5% of n-tert-butylacrylamide, 78% of diethylacrylamide, 17% of sodium 2-acrylamido-2-methylpropanesulfonate is synthesized in aqueous solution by radical polymerization.

During a second step, the polymer P1b is synthesized by a radical polymerization process by gel route from an aqueous charge comprising 2% by weight of the polymer P3 according to the following protocol: in a 1.5 L beaker are introduced 20 g of the polymer P3 composition (361 g of aqueous solution at 5.5% by weight of polymer P3), 79 g of acrylic acid, 403 g of acrylamide at 50% by weight in water and 70 g of sodium chloride. The neutralization of the charge is done using 87 g of sodium hydroxide at 50% by weight in water in order to reach a pH between 6.5-7.5. The charge is then cooled to 0° C. before being placed in a Dewar flask. 1.5 g of azobisisobutyronitrile are then introduced into the charge which is then homogenized using a hand mixer at a speed of 500 rpm for 20 seconds before being degassed under nitrogen bubbling for 20 minutes.

0.3 g of sodium hypophosphite, 3.8 mg of diethylene triamine penta acetic acid (DTPA) are then added to the charge, then the reaction is initiated by successive additions of 11.4 mg of sodium persulfate then 8.2 mg of Mohr's salt. The reaction time is 60 minutes, for a final temperature of 94° C. The polymer P1b obtained is in the form of a gel. Therefore, it is possible to granulate it and then dry it in an air stream at 70° C. for 60 minutes to obtain a polymeric composition CP1b. The dry grains of polymeric composition CP1b are then ground to obtain a powder with a particle size of less than 1.7 mm. The polymeric composition CP1b obtained is 100% water-soluble and comprises the polymer P1b which has a molar mass of 1,250,000 Da.

### II. Synthesis of a Polymer P2:

### Example 3 (P2a: Counterexample): Synthesis of the Polymer P2a

The polymer P2a is synthesized by a radical polymerization process by gel route from an aqueous charge comprising 30.6% by weight of monomers according to the following protocol: in a 1.5 L beaker are introduced 79 g of acid acrylic, 403 g of acrylamide at 50% by weight in water and 70 g of sodium chloride. The neutralization of the charge is done using 87 g of sodium hydroxide at 50% by weight in water in order to reach a pH between 6.5-7.5. The charge is then cooled to 0° C. before being placed in a Dewar flask. 1.5 g of azobisisobutyronitrile are then introduced into the charge which is then homogenized using a hand mixer at a speed of 500 rpm for 20 seconds before being degassed under nitrogen bubbling for 20 minutes.

0.23 g of sodium hypophosphite, 3.8 mg of diethylene triamine penta acetic acid (DTPA) are then added to the charge, then the reaction is initiated by successive additions of 11.4 mg of sodium persulfate then 8.2 mg of Mohr's salt. The reaction time is 60 minutes, for a final temperature of 94° C. The polymer P2a obtained is in the form of a gel. Therefore, it is possible to granulate it and then dry it in an air stream at 70° C. for 60 minutes. The dry grains of polymer P2a are then ground to obtain a powder with a particle size of less than 1.7 mm. The polymer P2a obtained is 100% water-soluble and has a molar mass of 1,800,000 Da.

### Example 4 (P2b: Invention): Synthesis of the Polymer P2b

The polymer P2b is synthesized by a radical polymerization process by gel route from an aqueous charge comprising 30.0% by weight of monomers according to the following protocol: in a 1.5 L beaker are introduced 65 g of acid acrylic, 430 g of acrylamide at 50% by weight in water and 70 g of sodium chloride. The neutralization of the charge is done using 72 g of sodium hydroxide at 50% by weight in water in order to reach a pH between 6.5-7.5. The charge is then cooled to 0° C. before being placed in a Dewar flask. 1.5 g of azobisisobutyronitrile are then introduced into the charge which is then homogenized using a hand mixer at a speed of 500 rpm for 20 seconds before being degassed under nitrogen bubbling for 20 minutes.

20 mg of sodium hypophosphite, 3.8 mg of diethylene triamine penta acetic acid (DTPA) are then added to the charge, then the reaction is initiated by successive additions of 11.4 mg of sodium persulfate then 8.2 mg of Mohr's salt. The reaction time is 60 minutes, for a final temperature of 94° C. The polymer P2b obtained is in the form of a gel. Therefore, it is possible to granulate it and then dry it in an air stream at 70° C. for 60 minutes. The dry grains of polymer P2b are then ground to obtain a particle size of less than 1.7 mm. The polymer P2b obtained is 100% water-soluble and has a molar mass of 12,000,000 Da.

### III. Manufacture of Agglomerates

In the following examples, iron ore agglomerates are prepared using the binding composition as described herein, the exact compositions and amounts being shown in Table 2. Compositions according to the invention (“invention”) and counterexample (“CEx”) compositions, falling outside the scope of the invention, are also prepared. The amounts of binding agents (in percent by weight) given in Table 2 are based on the total weight of the iron ore concentrate. The iron ore concentrate used in the examples in Table 2 is a hematite ore concentrate.

Table 1 below shows the nature of the elements that may be present in the binding composition.

TABLE 1
Organic and inorganic binding agents.

| | | CP1b | | | |
|---|---|---|---|---|---|
| | | comprising | | | |
| | P1a | P1b | P2a | P2b | LI |
| | (CEx) | (Invention) | (CEx) | (Invention) | (Invention) |
| Compound | Organic | | | | Inorganic |
| Nature | Polymeric | | | | Sodium silicate |
| Molecular mass | 100,000 | 1,250,000 | 1,800,000 | 12,000,000 | / |
| Anionicity | 0 | 28 | 23 | 28 | / |

To prepare said agglomerates, in a first step, the binding composition is mixed into the dry ore concentrate and homogenized with the required amount of water (moisture content between 2 and 5% by weight). The ore concentrate is mixed with the binding composition using a mixer of the KitchenAid® type (up to 3 kg of concentrate) and Hobart (greater than 3 kg of concentrate).

After a mixing time of between 2 and 4 minutes, the ore concentrate is deposited in the inlet hopper of a tangential wheel compactor which may be SAHUT-CONREUR, EURAGGLO or KOMAREK. The finished agglomerates, of sizes between 3.5 and 4.5 cm for volumes between 8 and 10 cm³, are recovered at the outlet of the compactor. These agglomerates are placed in the oven at 105° C. for 2 to 4 hours in order to dry them completely (knowing that the more inorganic bonding agent there is, the longer the cooking time must be extended).

The number of drops and the dry strength of the agglomerates obtained were measured for each case, the results being collated in Table 2.

As explained in Table 2, different comparative binding compositions (CEx 1 to CEx 10) and according to the invention (C1 to C5) were produced. They all consist of inorganic bonding agent LI and two organic bonding agents which are the polymeric composition CP1 and polymer P2 previously synthesized. In each case, the binding composition is produced by blending via a mixture allowing the homogenization of the three components.

The process for making ore agglomerates is generally known to a person skilled in the art. Different green ore agglomerates were produced to test the different binding compositions.

### Number of Wet Drops (NWD)

The number of wet drops was determined by repeatedly dropping an agglomerate from a height of 46 cm onto a steel plate placed horizontally until a visible crack formed on the surface of the pellet. The number of times necessary for the pellet thus dropped to reach its point of fracture/cracking was determined. This measurement is determined for 20 pellets. The average of these 20 measurements is called the number of wet drops (NWD).

### Dry Compressive Strength (DCS)

20 green pellets of sizes between 3.5 and 4.5 cm for volumes between 8 and 10 cm³, were placed in an oven at 105° C. for 2 to 4 hours in order to dry them completely. After drying, the dried pellets were placed one by one in a standard SCAINE brand measuring device. The maximum applied force at which the pellet cracked was determined. The average of these 20 measurements is called “dry compressive strength” (DCS).

TABLE 2
Amount of binding agent and minerals per agglomerate, measurements
of the physical properties of said agglomerates.

| | Dry | | Elements of the binding | | | | | | | |
|---|---|---|---|---|---|---|---|---|---|---|
| | concentrate | Water | composition (g) | | | | | Physical appearance of | | DCS |
| Tests | (g) | (g) | Pla | Plb | P2a | P2b | LI | agglomerates | NWD | (kg) |
| Cl | 9800 | 100 | 0 | 90 | 0 | 10 | 0 | Good, resistant, plastic | 10 | 380 |
| C2 | 9839 | 100 | 0 | 45 | 0 | 15 | 0 | Good, resistant, plastic | 8 | 440 |
| C3 | 9870 | 80 | 0 | 40 | 0 | 10 | 0 | Good, resistant, plastic | 5.5 | 357 |
| C4 | 9700 | 150 | 0 | 45 | 0 | 5 | 100 | Good, resistant, plastic | 6.5 | >500 |
| CEx 1 | 9800 | 100 | 0 | 100 | 0 | 0 | 0 | Formed, low resistance | 3 | 125 |
| CEx 2 | 9800 | 100 | 0 | 90 | 10 | 0 | 0 | Formed, low resistance | 3.5 | 135 |
| CEx 3 | 9800 | 100 | 90 | 0 | 0 | 10 | 0 | Formed, low resistance | 5 | 170 |
| CEx 4 | 9800 | 100 | 90 | 0 | 10 | 0 | 0 | Formed, low resistance | 4 | 165 |
| CEx 5 | 9800 | 100 | 100 | 0 | 0 | 0 | 0 | Formed, low resistance | 3 | 115 |

The application of cold agglomeration requires that the agglomerates have a dry hardness greater than 250 kg in order to allow the manufacturer to be able to add these agglomerates directly in furnaces at very high temperature (blast furnaces and electric furnaces).

Table 2 shows that the agglomerates of examples C1 to C4, which use the binding compositions according to the invention, are better compacted and their resistance is greater than that of the agglomerates of the comparative tests CEx 1 to CEx 5.

Effective compaction gives a very important agglomerate surface condition for the manufacturer because the cells of the compaction wheels will not be obstructed by fresh, uncompacted material. In addition, good compaction avoids having grainy and/or non-smooth surfaces which cause an increase in the abrasion indices, which leads to a decrease in the marketable size of the pellets and an increase in the dust content in the oven and during handling. The resistance and plasticity of the agglomerates make it possible to avoid breakage and, therefore, to reduce the tumbling indices.

The dry compressive strength for the tests of the agglomeration compositions C1 to C4 according to the invention is improved compared to the tests of the comparative binding compositions CEx 1 to CEx 5. This parameter is essential for the manufacturer because it makes it possible to know the behavior of agglomerates in very high temperature furnaces: increased dry compression strength will prevent broken agglomerates in the columns of blast furnaces and/or electric furnaces, therefore a drop in productivity due to the presence of an excessive content of fines.

The number of drops of the agglomerates is also very important for the application of cold agglomeration in order to avoid any breakage of the agglomerates before complete drying, which would lead to an increase in the fine particles and a reduction in the dry strength of the agglomerates.

Comparatively, the binding compositions C1, C2 and C3 make it possible to obtain the values required by the cold agglomeration application. It is also observed that the choice of the molecular weights of the polymers P1 and P2 is important in order to have good physical properties. The binding compositions according to the invention demonstrate their effectiveness even at a lower dosage, which is important for the manufacturer, because this makes it possible to reduce the costs of logistics and production of agglomerates by the cold agglomeration method.

The tests of the comparative binding compositions CEx 1 to CEx 5 demonstrate that it is essential to work with the binding compositions of the polymeric composition CP1 and P2 of the invention.

1. A binding composition, for the manufacture of ore agglomerates, comprising at least the following two distinct organic binding agents CP1 and P2:
a polymeric composition CP1 comprising a non-ionic or anionic water-soluble synthetic polymer P1 with a weight average molecular weight of between 500,000 and 3 million Daltons,
a non-ionic or anionic water-soluble synthetic polymer P2 with a weight average molecular weight greater than 2 million Daltons,
wherein the polymeric composition CP1 and the polymer P2 are both present in the form of solid particles,
wherein P1 is obtained by a gel polymerization process of at least one non-ionic or anionic monomer in the presence of:
at least 1% by weight of a polymer P3, said polymer P3 contains at least one hydrophobic monomer, or
at least one hydrophobic monomer, the polymeric composition CP1 comprising from 0.1% to 20% by weight of the at least one hydrophobic monomer, said hydrophobic monomer being polymerized.

2. The binding composition according to claim 1, wherein said binding composition contains at least 50% by weight of polymeric composition CP1.

3. The binding composition according to claim 1, wherein the polymer P1 contains at least 50 mol % of at least one non-ionic monomer.

4. The binding composition according to claim 1, wherein the polymer P1 is non-ionic.

5. The binding composition according to claim 3, wherein the non-ionic monomer(s) of P1 are chosen from the group consisting of acrylamide, methacrylamide, N-vinylformamide (NVF), N-vinyl acetamide, N-vinylpyridine, N-vinylpyrrolidone (NVP), N-vinyl imidazole, N-vinyl succinimide, acryloyl morpholine (ACMO), acryloyl chloride, glycidyl methacrylate, glyceryl methacrylate, diacetone acrylamide, hydroxyalkyl (meth)acrylates, aminoalkyl (meth)acrylates, aminoalkyl (meth)acrylamido, thioalkyl (meth)acrylates and mixtures thereof.

6. The binding composition according to claim 3, wherein at least one non-ionic monomer of the polymer P1 is acrylamide.

7. The binding composition according to claim 1, wherein the polymer P1 is a copolymer of acrylamide and sodium acrylate.

8. The binding composition according to claim 1, characterized in that wherein the polymer P1 comprises at least one hydrophobic monomer chosen from haloalkyl derivatives of methacrylamidodimethyl aminopropyl comprising a C₈-C₁₆ alkyl chain, ethoxylated behenyl methacrylate, diethylacrylamide, n-tert-butylacrylamide, and mixtures thereof.

9. The binding composition according to claim 1, that wherein the polymer P3 contains between 10 and 90% by weight of at least one hydrophobic monomer.

10. The binding composition according to claim 1, characterized in that wherein the polymer P3 is a terpolymer of diethylacrylamide, n-tert-butylacrylamide and sodium 2-acrylamido-2-methylpropanesulfonate.

11. The binding composition according to claim 1, wherein the polymer P3 is functionalized at the end of the polymer chain by at least one group chosen from: hydroxyl, cyano, amine, phosphate, phosphonate, sulphate, sulphonate, xanthate, trithiocarbonate, dithiocarbamate, and dithioester.

12. The binding composition according to claim 1, wherein the polymer P3 is free of carbon-carbon double bonds.

13. The binding composition according to claim 1, wherein the polymer P2 is a copolymer containing between 5 and 100 mol % of sodium acrylate.

14. The binding composition according to claim 1, wherein the polymer P2 has a weight average molecular weight greater than the weight average molecular weight of the polymer P1.

15. Ore agglomerate containing between 2,000 and 50,000 ppm of the binding composition according to claim 1, relative to the weight of the ore agglomerate.

16. The binding composition according to claim 2, wherein the polymer P1 contains at least 50 mol % of at least one non-ionic monomer.

17. The binding composition according to claim 16, wherein the polymer P1 is non-ionic.

18. The binding composition according to claim 17, wherein the non-ionic monomer(s) of P1 are chosen from the group consisting of acrylamide, methacrylamide, N-vinylformamide (NVF), N-vinyl acetamide, N-vinylpyridine, N-vinylpyrrolidone (NVP), N-vinyl imidazole, N-vinyl succinimide, acryloyl morpholine (ACMO), acryloyl chloride, glycidyl methacrylate, glyceryl methacrylate, diacetone acrylamide, hydroxyalkyl (meth)acrylates, aminoalkyl (meth)acrylates, aminoalkyl (meth)acrylamido, thioalkyl (meth)acrylates and mixtures thereof.

19. The binding composition according to claim 18, wherein at least one non-ionic monomer of the polymer P1 is acrylamide.

20. The binding composition according to claim 19, wherein:
the polymer P1 is a copolymer of acrylamide and sodium acrylate; or
the polymer P1 comprises at least one hydrophobic monomer chosen from haloalkyl derivatives of methacrylamidodimethyl aminopropyl comprising a C₈-C₁₆ alkyl chain, ethoxylated behenyl methacrylate, diethylacrylamide, n-tert-butylacrylamide, and mixtures thereof.
